(19) United States
(12) Patent Application Publication
(10) Pub. No.: US 2019/0277624 A1
(43) Pub. Date: Sep. 12, 2019

(54) INFORMATION PROCESSING DEVICE, LENGTH MEASUREMENT METHOD, AND PROGRAM STORAGE MEDIUM

(71) Applicant: NEC Corporation, Tokyo (JP)

(72) Inventor: Takeharu KITAGAWA, Tokyo (JP)

(73) Assignee: NEC Corporation, Tokyo (JP)

(21) Appl. No.: 16/338,161

(22) PCT Filed: Sep. 20, 2017
(86) PCT No.: PCT/JP2017/033881

§ 371 Date: Mar. 29, 2019

(30) Foreign Application Priority Data
Sep. 30, 2016 (JP) 2016-194268

(51) Int. Cl. G01B 11/04; G01B 11/03; G06T 7/73

(52) U.S. Cl. CPC G01B 11/043; G06T 7/73; G01B 11/03

(57) ABSTRACT

In order to provide a technology with which it is possible to easily and accurately detect the length of a measured object on the basis of a captured image, this information processing device 70 is provided with a detection unit 71 and a calculation unit 72. The detection unit 71 detects feature locations from a captured image in which the measured object is photographed, the feature locations being locations on the measured object that form pairs, each feature location having a predetermined feature. The calculation unit 72 calculates the length between feature locations that form a pair based on the detection results from the detection unit 71.

### TECHNICAL FIELD

The present invention relates to a technique of measuring a length of a target object to be measured from a captured image in which the target object is captured.

### BACKGROUND ART

For technical improvement in culture fishery, growth of a cultured fish is observed. PTL 1 discloses a technique relevant to fish observation. In the technique in PTL 1, a shape and a size of a part such as a head, a trunk, or a caudal fin of a fish are estimated for each part based on the dorsally (or ventrally) captured images of the fish captured from an upper side (or a bottom side) and a lateral side of an aquarium, and a frontally captured image of a head side. The estimation of the shape and the size for each part of the fish is performed using a plurality of template images given for each part. In other words, the captured image of each part is collated with the template image of the part, and the size and the like of each part of a fish are estimated based on the known information such as the size of the part of the fish in the template image matching with the captured image.

PTL 2 discloses a technique of capturing a fish in water with a moving image camera and a still image camera, and detecting a fish figure based on the a captured moving image and a captured still image. Further, PTL 2 discloses a configuration of estimating a size of a fish using an image size (number of pixels).

### CITATION LIST

### Patent Literature

[PTL 1] Japanese Unexamined Patent Application Publication No. 2003-250382

[PTL 2] Japanese Unexamined Patent Application Publication No. 2013-201714

### SUMMARY OF INVENTION

### Technical Problem

In the technique described in PTL 1, the size of the part of the fish is estimated based on the information on the known size of the part of the fish in the template image. That is, in the technique in PTL 1, the size of the part of the fish in the template image is merely detected as the size of the part of a target fish, but no measurement is performed on the size of the part of the target fish. Thus, there arises a problem of difficulty in enhancing accuracy in size detection.

In PTL 2, although a configuration of detecting the image size (number of pixels) as a fish figure size is disclosed, no configuration of detecting an actual size of a fish is disclosed.

The present invention has been conceived in order to solve the above-described problem. In other words, a main object of the present invention is to provide a technique capable of easily and accurately detecting a length of an object to be measured based on a captured image.

### Solution to Problem

To achieve the object of the present invention, an information processing device of the present invention, as an aspect, includes:

a detection unit that detects feature parts of a target object to be measured from a captured image in which the target object is captured, the feature parts being paired and respectively having a predetermined feature; and

a calculation unit that calculates a length between the paired feature parts using a result of detection by the detection unit.

A length measurement system of the present invention, as an aspect, includes:

an imaging device that captures a target object to be measured; and

an information processing device that calculates a length between feature parts of the target object in a captured image captured by the imaging device, the feature parts being paired and respectively having a predetermined feature,

the information processing device includes:

a detection unit that detects the feature parts of the target object from the captured image in which the target object is captured; and

a calculation unit that calculates the length between the paired feature parts using a result of detection by the detection unit.

A length measurement method of the present invention, as an aspect, includes:

detecting feature parts of a target object to be measured from a captured image in which the target object is captured, the feature parts being paired and respectively having a predetermined feature; and

calculating a length between the paired feature parts using a result of the detection.

A program storage medium of the present invention, as an aspect, stores a computer program that causes a computer to execute:

detecting feature parts of a target object to be measured from a captured image in which the target object is captured, the feature parts being paired and respectively having a predetermined feature; and

calculating a length between the paired feature parts using a result of the detection.

Note that the main object of the present invention is also achieved by the length measurement method of the present invention associated with the information processing device of the present invention. Further, the main object of the present invention is also achieved by the computer program of the present invention associated with the information processing device of the present invention and the length measurement method of the present invention, and by the program storage medium storing the computer program.

### Advantageous Effects of Invention

The present invention is able to easily and accurately detect a length of an object to be measured based on a captured image.

### BRIEF DESCRIPTION OF DRAWINGS

FIG. 1 is a block diagram simplistically representing a configuration of an information processing device of a first example embodiment according to the present invention,

FIG. 2 is a block diagram simplistically representing a configuration of a length measurement system including the information processing device of the first example embodiment.

FIG. 3 is a block diagram simplistically representing a configuration of an information processing device of a second example embodiment according to the present invention.

FIG. 4A is a diagram illustrating a supporting member supporting imaging devices (cameras) providing captured images for the information processing device of the second example embodiment,

FIG. 4B is a diagram illustrating a mount example of cameras on a supporting member supporting imaging devices (cameras) providing captured images for the information processing device of the second example embodiment.

FIG. 5 is a diagram illustrating a mode of capturing, with cameras, a fish being a target object to be measured in the second example embodiment.

FIG. 6 is a diagram illustrating one example of a display mode of displaying, on a display device, captured images taken by capturing a fish being a target object to be measured,

FIG. 7 is a diagram illustrating one example of an investigation range for use in processing of the information processing device of the second example embodiment.

FIG. 8 is a diagram representing an example of reference data of feature parts for use in measurement of a length of fish.

FIG. 9 is a diagram illustrating an example of captured images of a fish that are not employed as reference data in the second example embodiment.

FIG. 10 is a diagram illustrating processing of measuring, by the information processing device of the second example embodiment, a length of target fish.

FIG. 11 is a diagram further illustrating processing of measuring the length of target fish in the second example embodiment.

FIG. 12 is a flowchart representing a procedure for the processing of measuring the length in the information processing device of the second example embodiment.

FIG. 13 is a block diagram representing particular units extracted in a configuration of an information processing device of a third example embodiment according to the present invention.

FIG. 14 is a diagram illustrating one example of processing of setting, by the information processing device of the third example embodiment, an investigation range on a captured image.

FIG. 15 is a diagram representing examples of reference data for use in setting the investigation range in the third example embodiment.

FIG. 16 is a diagram further representing examples of the reference data for use in setting the investigation range.

FIG. 17 is a diagram representing one example of an investigation range defined on a captured image by the information processing device of the third example embodiment.

FIG. 18 is a diagram illustrating one example of a method to acquire training data in the case of generating the reference data by supervised machine learning.

FIG. 19 is a diagram representing examples of reference data for use in processing of detecting a tip of head of a fish being a target object to be measured.

FIG. 20 is a diagram representing still the other examples of the reference data for use in the processing of detecting the tip of head of the fish being the target object.

FIG. 21 is a diagram representing examples of reference for use in processing of detecting a caudal fin of the fish being the target object.

FIG. 22 is a diagram representing still the other examples of the reference data for use in the processing of detecting the caudal fin of the fish being the target object.

FIG. 23 is a block diagram simplistically representing a configuration of an information processing device of another example embodiment according to the present invention.

### EXAMPLE EMBODIMENT

Hereinafter, example embodiments according to the present invention will be described with reference to the drawings.

### First Example Embodiment

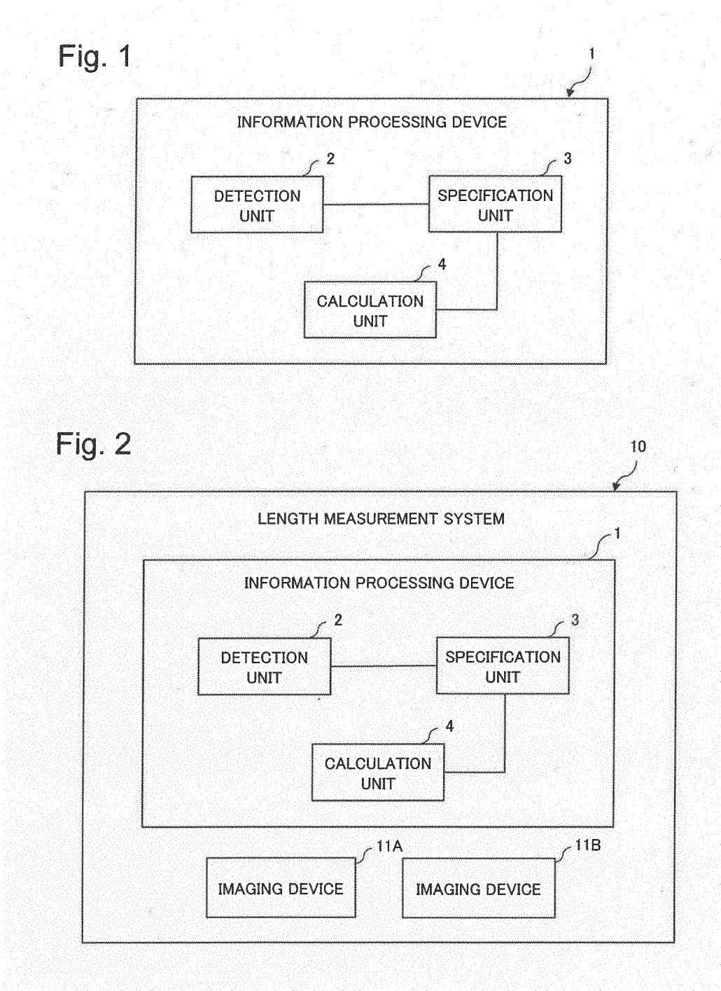

FIG. 1 is a block diagram simplistically representing configuration of an information processing device of a first example embodiment according to the present invention. This information processing device 1 is incorporated in a length measurement system 10 as represented in FIG. 2, and includes a function of calculating a length of a target object to be measured. The length measurement system 10 includes a plurality of imaging devices 11A and 11B in addition to the information processing device 1. The imaging devices 11A and 11B are devices that are arranged side by side at an interval and capture the target object in common. Captured images captured by the imaging devices 11A and 11B are provided for the information processing device 1 through wired communication or wireless communication. Alternatively, the captured images captured by the imaging devices 11A and 11B may be registered on a portable storage medium (for example, a secure digital (SD) card) in the imaging devices 11A and 11B, and may be read from the portable storage medium into the information processing device 1.

The information processing device 1 includes a detection unit 2, a specification unit 3, and a calculation unit 4, as represented in FIG. 1. The detection unit 2 includes a function of detecting, from a captured image in which the target object is captured, feature parts being paired parts of the target object and respectively having a predetermined feature.

The specification unit 3 includes a function of specifying position coordinates in a coordinate space representing positions of the detected feature parts. In the processing of specifying position coordinates, the specification unit 3 uses display position information on display positions where feature parts are displayed in a plurality of captured images taken by capturing the target object from mutually different positions. Further, the specification unit 3 also uses interval information on the interval between the capturing positions where the plurality of captured images in which the target object is captured have been respectively captured.

The calculation unit 4 includes a function of calculating a length between the paired feature parts based on the specified position coordinates of feature parts.

The information processing device 1 of the first example embodiment detects, from the plurality of captured images taken by capturing the target object from mutually different positions, the feature parts being paired parts of the target object and respectively having the predetermined feature. Then, the information processing device 1 specifies the position coordinates in a coordinate space representing positions of the detected feature parts, and calculates a length between paired feature parts based on the specified position coordinates of the feature parts. Through such processing, the information processing device 1 is able to measure a length between paired feature parts of the target object.

In other words, the information processing device 1 includes a function of detecting the paired feature parts for use in length measurement from the captured image in which the target object is captured. Thus, a measurer who measures the length of the target object does not need to perform work of finding the paired feature parts for use in the length measurement from the captured image in which the target object is captured. Further, the measurer does not need to perform work of inputting information on positions of the found feature parts to the information processing device 1. In this manner, the information processing device 1 of the first example embodiment is able to reduce labor on the measurer who measures the length of the target object.

Moreover, the information processing device 1 specifies the position coordinates in the coordinate space of the feature parts detected from the captured image, and calculates the length of the target object by using the position coordinates. In this manner, the information processing device 1 calculates the length of the target object based on the position coordinates in a coordinate space, and thus, is able to enhance accuracy in the length measurement. In other words, the information processing device 1 of the first example embodiment is able to obtain an advantageous effect of being able to easily and accurately detect the length of the target object based on the captured image. Note that, in the example in FIG. 2, the length measurement system 10 includes the plurality of imaging devices 11A and 11B, but the length measurement system 10 may be constituted by one imaging device.

### Second Example Embodiment

A second example embodiment according to the present invention will be described below.

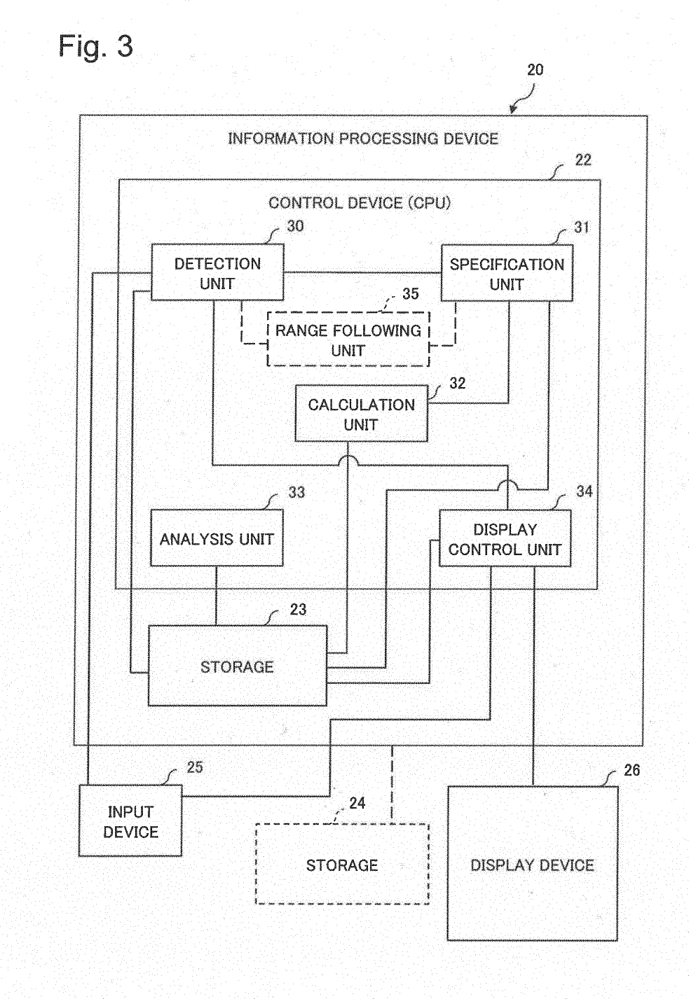

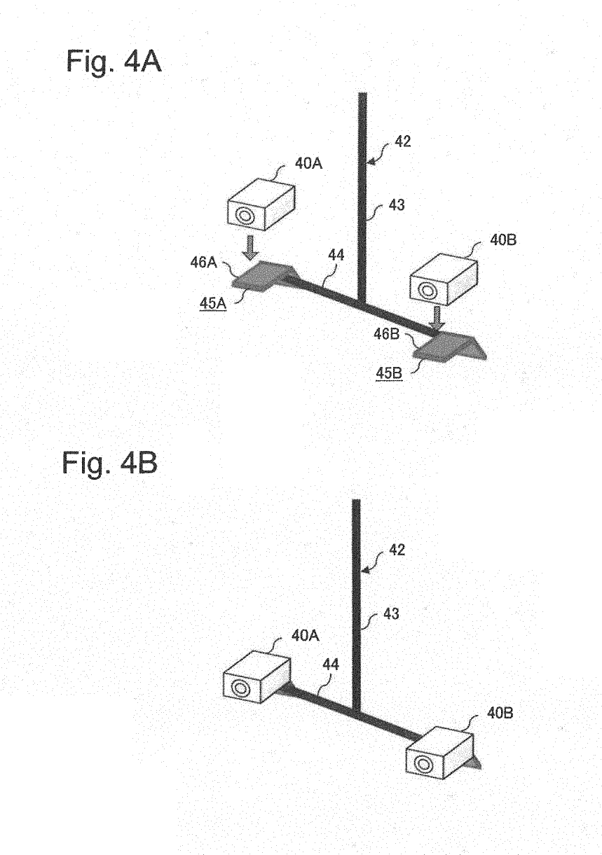

FIG. 3 is a block diagram simplistically representing a configuration of an information processing device of a second example embodiment according to the present invention. In the second example embodiment, an information processing device 20 includes a function of calculating a length of fish from captured images of a fish being a target object to be measured captured by a plurality of (two) cameras 40A and 40B as represented in FIG. 4A. The information processing device 20 constitutes a length measurement system together with the cameras 40A and 40B.

In the second example embodiment, cameras 40A and 40B are imaging devices including a function of capturing a moving image. However, even without a moving image capturing ion for example, imaging devices capturing still images intermittently at set time intervals may be employed as the cameras 40A and 40B.

Herein, the cameras 40A and 40B capture a fish in a state of being arranged side by side at an interval as represented in FIG. 4B, by being supported and fixed by a supporting member 42 as represented in FIG. 4A. The supporting member 42 is constituted by including an expandable rod 43, an attachment rod 44 and attachment fixtures 45A and 45B. In this example, the expandable rod 43 is a freely expandable rod member, and further, includes a configuration being fixable in length at an appropriate length for use within a range of expandable length. The attachment rod 44 is configured by a metallic material such as, for example, aluminum, and is joined to the expandable rod 43 in a perpendicular manner. The attachment fixtures 45A and 45B are fixed to the attachment rod 44 respectively at parts being symmetrical about a joint portion with the expandable rod 43. The attachment fixtures 45A and 45B include mount faces 46A and 46B on winch the cameras 40A and 40B are to be mounted, and are provided with configurations of fixing the cameras 40A and 40B mounted on the mount faces 46A and 46B to the mount faces 46A and 46B without looseness by using, for example, screws and the like.

The cameras 40A and 40B can maintain a state of being arranged side by side at a preset interval, by being fixed to the supporting member 42 having a configuration as described above. Further, in the second example embodiment, cameras 40A and 40B are fixed to the supporting member 42 in such a manner that lenses provided on the cameras 40A and 40B face in the same direction and optical axes of the lenses are parallel to each other. Note that a supporting member supporting and fixing the cameras 40A and 40B is not limited to the supporting member 42 represented in FIG. 4A and the like. For example, a supporting member supporting and fixing the cameras 40A and 40B may be configured to use one or a plurality of ropes instead of the expandable rod 43 of the supporting member 42, and to suspend the attachment rod 44 and the attachment fixtures 45A and 45B with the ropes.

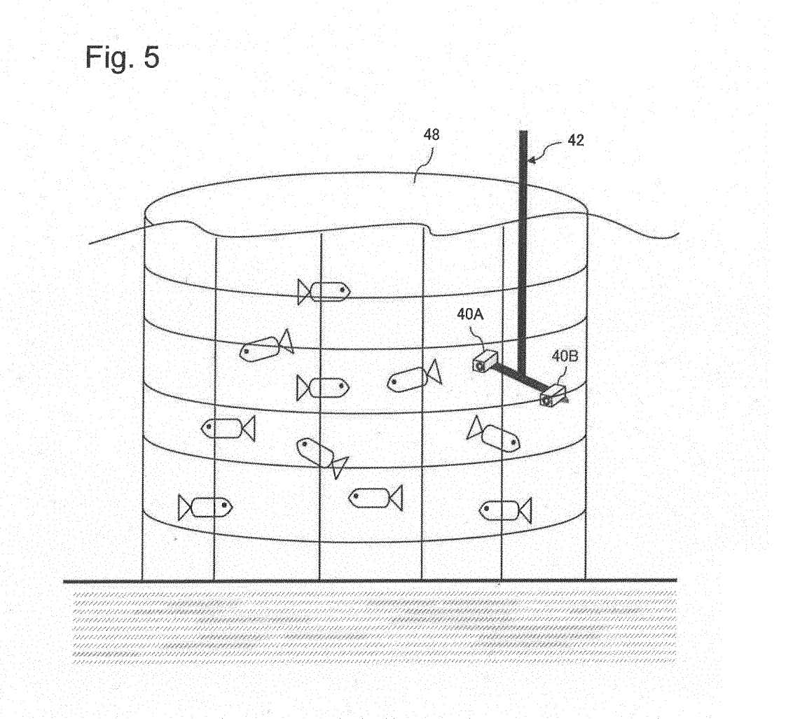

The cameras 40A and 40B are made to enter, in a state of being fixed to the supporting member 42, a culture cage 48 in which fishes are cultured as represented in FIG. 5, for example, and are arranged at a water depth and with a direction of lenses that are determined as being appropriate for observation of the fishes (in other words, appropriate for capturing of the fishes being the target objects). Note that there are various methods conceived as a method to arrange and fix the supporting member 42 (the cameras 40A and 40B) made to enter the culture cage 48 at an appropriate water depth and with an appropriate direction of lenses. Herein, any of the methods may be employed, and description therefor will be omitted. Further, calibration of the cameras 40A and 40B is performed by using an appropriate calibration method in consideration of an environment of the culture cage 48, the type of the fishes to be measured, and the like. Herein, description for the calibration method will be omitted.

Furthermore, as a method to start capturing with the cameras 40A and 40B and a method to stop capturing, an appropriate method in consideration of performance of the cameras 40A and 40B, an environment of the culture cage 48, and the like is employed. For example, a fish observer (measurer) manually starts capturing before making the cameras 40A and 40B enter the culture cage 48, and manually stops capturing after making the cameras 40A and 40B exit from the culture cage 48. Further, when the cameras 40A and 40B include a function of wireless communication or wired communication, an operation device capable of transmitting information for controlling capturing start and capturing stop is connected with the cameras 40A and 40B. Then, capturing start and capturing stop of the cameras 40A and 40B in water may be controlled by an operation performed by the observer on the operation device.

Further, a monitoring device may be used. The monitoring device is capable of receiving the captured image of being capturing from one or both of the camera 40A and the camera 40B through wired communication or wireless communication. In this case, an observer can view the captured image of being captured through the monitoring device. This makes it possible for the observer to change, for example, a capturing direction and the water depth in of the cameras 40A and 40B while viewing the captured image of being captured. Note that a mobile terminal with a monitoring function may be used as the monitoring device.

Incidentally, in processing of calculating the length of fish, the information processing device 20 uses the captured image by the camera 40A and the captured image by the camera 40B that have been captured at the same time. In consideration of this fact, it is preferred for the cameras 40A and 40B to also capture a change serving as a mark for use in e alignment during capturing, in order to easily obtain the captured image by the camera 40A and the captured image by the camera 40B that have been captured at the same time. For example, as the mark for use in time alignment, light being emitted for a short period of time by automatic control or manually by an observer may be used, and the light may be captured by the cameras 40A and 40B. This facilitates time alignment (synchronization) between the captured image by the camera 40A and the captured image by the camera 40B based on the light captured in the captured images by the cameras 40A and 40B.

The captured images by the cameras 40A and 40B as described above may be imported to the information processing device 20 through wired communication or wireless communication, may be stored on a portable storage medium and thereafter imported to the information processing device 20 from the portable storage medium.

The information processing device 20 generally includes a control device 22 and a storage 23, as represented in FIG. 3. Further, the information processing device 20 is connected with an input device (for example, a keyboard or a mouse) 25 that inputs information to the information processing device 20 with an operation performed by, for example, an observer, and a display device 26 that displays information. Furthermore, the information processing device 20 may be connected with an external storage 24 provided separately from the information processing device 20.

The storage 23 has a function of storing various kinds of data or computer programs (hereinafter, also referred to as programs), and is implemented by, for example, a storage medium such as a hard disk device or a semiconductor memory. The storage 23 included in the information processing device 20 is not limited to one in number, and a plurality of types of storages may be included in the information processing device 20. In this case, a plurality of storages are collectively referred to as the storage 23. Further, similarly to the storage 23, the storage 24 also has a function of storing various kinds of data or computer programs, and is implemented by, for example, a storage medium such as a hard disk device or a semiconductor memory. Note that, when the information processing device 20 is connected with the storage 24, the storage 24 stores appropriate information. Further, in this case, the information processing device 20 executes, as appropriate, processing of writing information and processing of reading information to and from the storage 24. However, in the following description, description relating to the storage 24 will be omitted.

In the second example embodiment, the storage 23 stores the captured images by the cameras 40A and 40B in a state of being associated with information on a camera used for capturing and information on a capturing situation such as information on a capturing time.

The control device 22 is constituted by, for example, a central processing unit (CPU). With the CPU executing the computer program stored in the storage 23, for example, the control device 22 can have functions as follows, in other words, the control device 22 includes, as functional units, a detection unit 30, a specification unit 31, a calculation unit 32, an analysis unit 33, and a display control unit 34.

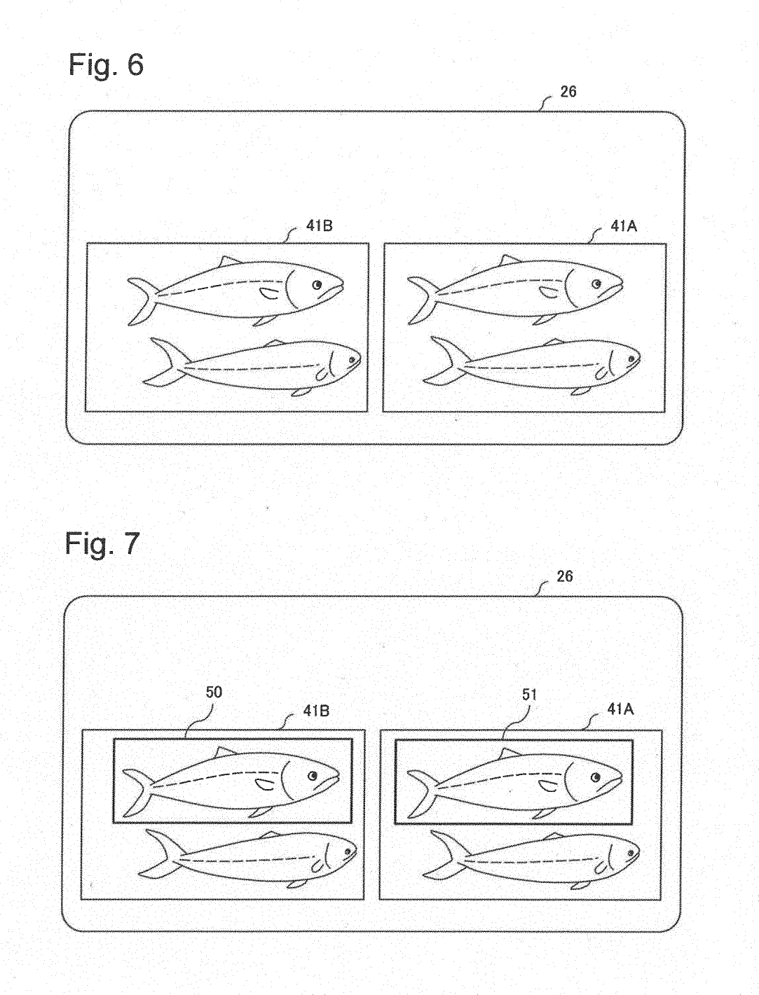

The display control unit 34 includes a function of controlling a display operation of the display device 26. For example, when receiving a request from the input device 25 to reproduce captured images by the cameras 40A and 40B, the display control unit 34 reads the captured images by the cameras 40A and 40B from the storage 23 in response to the request, and displays the captured images on the display device 26. FIG. 6 is a diagram representing a display example of captured images by the cameras 40A and 40B on the display device 26. In the example in FIG. 6, the captured image 41A by the camera 40A and the captured image 41B by the camera 40B are displayed side by side in a manner of double-screen display.

Note that the display control unit 34 includes a function of allowing the captured images 41A and 41B to synchronize in such a manner that the captured images 41A and 41B captured at the same time are concurrently displayed on the display device 26. For example, the display control unit 34 includes a function of allowing an observer to adjust reproduced frames of the captured images 41A and 41B by using the mark for time alignment as described above concurrently captured by the cameras 40A and 40B.

The detection unit 30 includes a function of prompting an observer to input information designating a target fish to be measured in the captured images 41A and 41B being displayed (reproduced) on the display device 26. For example, the detection unit 30 causes, by using the display control unit 34, the display device 26 on which the captured images 41A and 41B are displayed as in FIG. 6, to display a message representing that “please designate (select) the target fish”. In the second example embodiment, setting is made such that, by an operation of the input device 25 performed by an observer, a frame 50 encloses the target fish as represented in FIG. 7 and thereby designates the target fish. The frame 50 is in a shape of, for example, a rectangle (including a square) whose size and aspect ratio can be varied by an observer. The frame 50 is an investigation range to be subjected to detection processing performed by the detection unit 30 on the captured image. Note that, when an observer is executing work of designating the target fish with the frame 50, the captured images 41A and 41B are in a state of being stationary at a pause state.

In the second example embodiment, a screen area displaying one of the captured images 41A and 419B (for example, a left-side screen area in FIGS. 6 and 7) is set as an operation screen, and a screen area displaying another one of the captured images 41A and 41B (for example, side screen area in FIGS. 6 and 7) is set as a reference screen. The detection unit 30 includes a function of calculating a display position of a frame 51 in the captured image 41A on the reference screen based on interval information on an interval between the cameras 40A and 40B. The display position of the frame 51 is the same area as an area being designated with the frame 50 in the captured image 41B. Note that the detection unit 30 includes a function of varying a position and a size of the frame 51 in the captured image 41A in a manner of following a position and a size of the frame 50 during adjustment of the position and the size in the captured image 41B. Alternatively, the detection unit 30 may include a function of causing the frame 51 to be displayed in the captured image 41A after the position and the size of the frame 50 are defined on the captured image 41B. Furthermore, the detection unit 30 may include both a function of varying the position and the size of the frame 51 in a manner of following adjustment of the position and the size of the frame 50, and a function of causing the frame 51 to be displayed after the position and the size of the frame 50 are defined, and may execute one of the functions alternatively selected by, for example, an observer. Further, the function of setting the frame 51 in the captured image 41A based on the frame 50 designated in the captured image 41B as described above may be executed by a range following unit 35 as represented by a dotted line in FIG. 3, instead of the detection unit 30.

The detection unit 30 further includes a function of detecting paired feature parts having predetermined features of the target fish within the frames 50 and 51 designated as investigation ranges in the captured images 41A and 41B. In the second example embodiment, a tip of head and a caudal fin of fish are set as the paired feature parts. There are various methods as a method to detect the tip of head and the caudal fin of fish being feature parts from the captured images 41A and 41B. Herein, an appropriate method in consideration of processing performance and the like of the information processing device 20 is employed, and examples thereof include a method as follows.

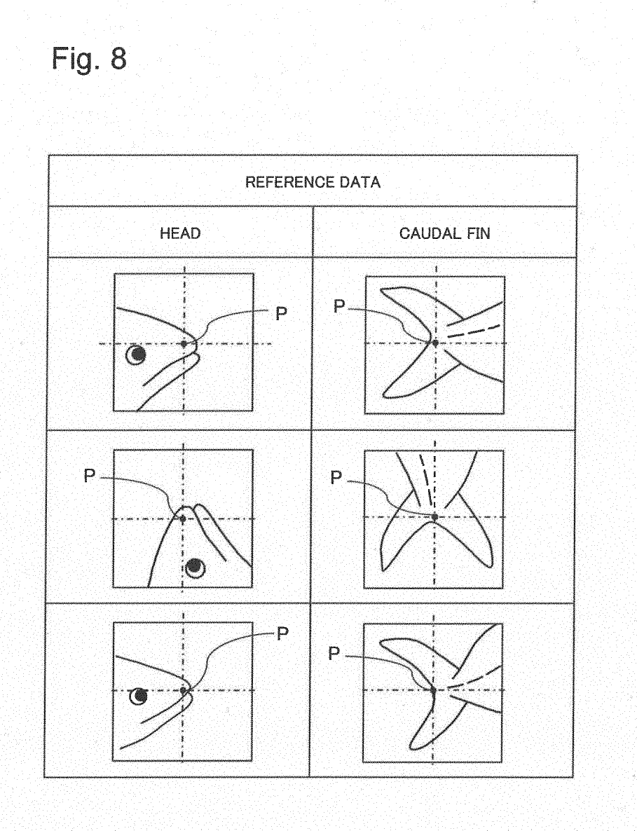

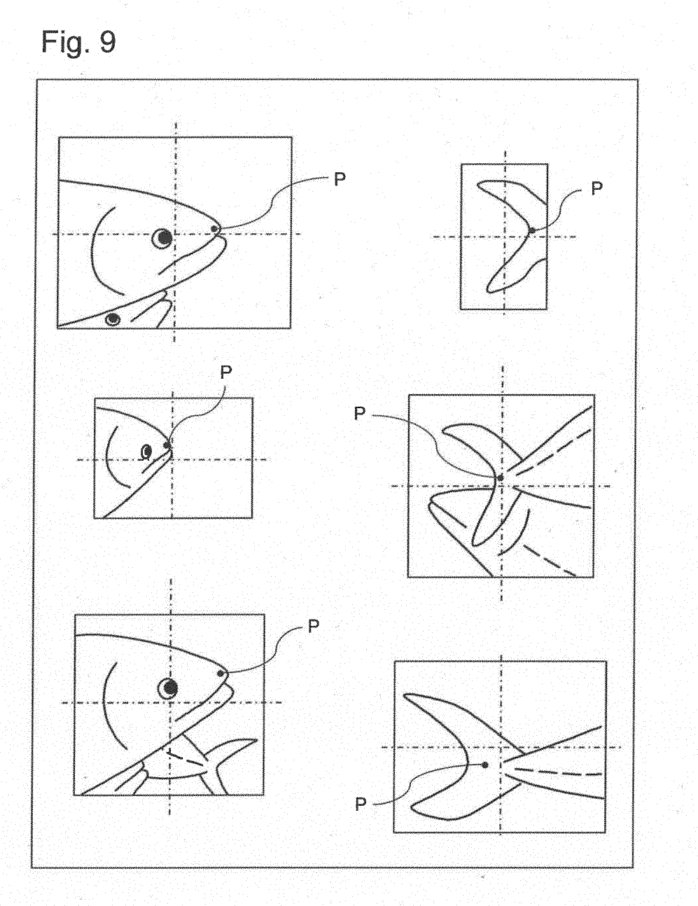

For example, regarding the tip of head and the caudal fin of fish of a type to be measured, a plurality of pieces of reference data (reference part images) of fish in different directions and shapes as represented in FIG. 8 are registered in the storage 23. These pieces of reference data are reference part images representing sample images of the tip of head and the caudal fin of fish being feature parts. The pieces of reference data are generated by machine learning using training data (training images). The training data is obtained by extracting regions of the captured image where respective feature parts of being the tip of head and the caudal fin are captured from a large number of captured images in which the fish of the type to be measured is captured.

The information processing device 20 of the second example embodiment measures a length between the tip of head and the caudal fin of fish as the length of fish. For this reason, the tip of head and the caudal fin of fish are parts being at both ends of a measurement portion in measurement of the length of fish. In consideration of this fact, herein, reference data are generated by machine learning using training data extracted in such a manner that each measurement point of the tip of head and the caudal fin being at both ends of the measurement portion of fish in measurement of the length of fish comes to the center. Thus, the center of reference data has a meaning of representing a measurement point P of the tip of head or the caudal fin of fish, as represented in FIG. 8.

In contrast to this, when regions where the tip of head and the caudal fin are merely captured in no consideration of measurement points P as represented in FIG. 9 are extracted as training data, and reference data are generated based on the training data, the center of the reference data does not always represent a measurement point P. That is, in this case, the center position of the reference data does not have a meaning of representing the measurement point P.

Reference data as described above are collated with images within investigation ranges (the frames 50 and 51) designated in the captured images 41A and 41B, and thereby image regions matching with the reference data are detected in the frames 50 and 51.

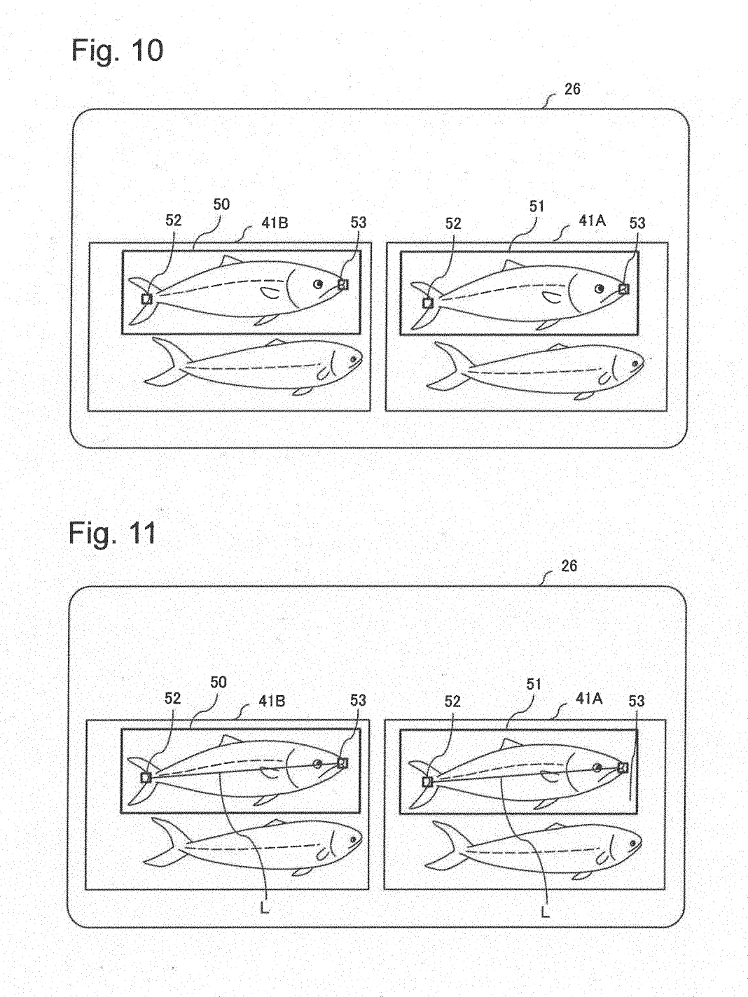

The detection unit 30 further includes a function of causing e display device 26 to specify positions of the tip of head and the caudal fin of fish being detected feature parts using the display control unit 34. FIG. 10 represents display examples of the detected tip of head parts and the detected caudal fin parts of fish being specified with frames 52 and 53 on the display device 26.

The specification unit 31 includes a function of specifying position coordinates in a coordinate space that represent positions of paired feature parts (namely, the tip of head and the caudal fin) of target fish detected by the detection unit 30. For example, the specification unit 31 receives, from the detection unit 30, display position information on display positions where the tip of head and the caudal fin of target fish detected by the detection unit 30 are displayed in the captured images 41A and 41B. Further, the specification unit 31 reads, from the storage 23, the interval information on the a between the cameras 40A and 40B (that is, between the capturing positions). Then, using these pieces of information, the specification unit 31 specifies (calculates) the position coordinates in a coordinate space of the tip of head and the caudal fin of target fish by triangulation. In this case, when the detection unit 30 detects the feature parts by using the reference data whose centers are the measurement points P, the specification unit 31 uses the display position information on the display positions in the captured images 41A and 41B where the centers of the feature parts detected by the detection unit 30 are displayed.

The calculation unit 32 includes a function of calculating, as a length of target fish, an interval L between the paired feature parts (the tip of head and the caudal fin) as represented in FIG. 11 using the position coordinates (spatial position coordinates) of the feature parts (the tip of head and the caudal fin) of target fish specified by the specification unit 31. The length L of fish calculated by the calculation unit 32 in this manner is registered in the storage 23, in a state of being associated with predetermined information such as, for example, an observation date and time.

The analysis unit 33 includes a function of executing a predetermined analysis using a plurality of pieces of information on the length L of fish registered in the storage 23 and information associated with the information. For example, the analysis unit 33 calculates an average value of the lengths L of a plurality of fishes within the culture cage 48 on the observation date, or the average value of the length L of target fish. Note that, as one example in the case of calculating the average value of the length L of target fish, use is made of the plurality of the lengths L of target fish that are calculated using images of the target fish in a plurality of frames of a moving image captured within a short period of time such as one second. Further, in the case of calculating the average value of the lengths L of the plurality of fishes within the culture cage 48 without individual identification for the fishes, there is a concern about overlapping use of a value of an identical fish as values of the lengths L of fishes for use in calculation of the average value. However, in the case of calculating the average value of the lengths L of a large number of fishes such as a thousand fishes or more, there is a small adverse effect on accuracy in calculation of the average value due to overlapping use of a value.

Further, the analysis unit 33 may calculate a relation between the lengths L of fishes within the culture cage 48 and the number of the fishes (fish count distribution with respect to lengths of fishes). Furthermore, the analysis unit 33 may calculate temporal transition of the length L of fish representing growth of the fish.

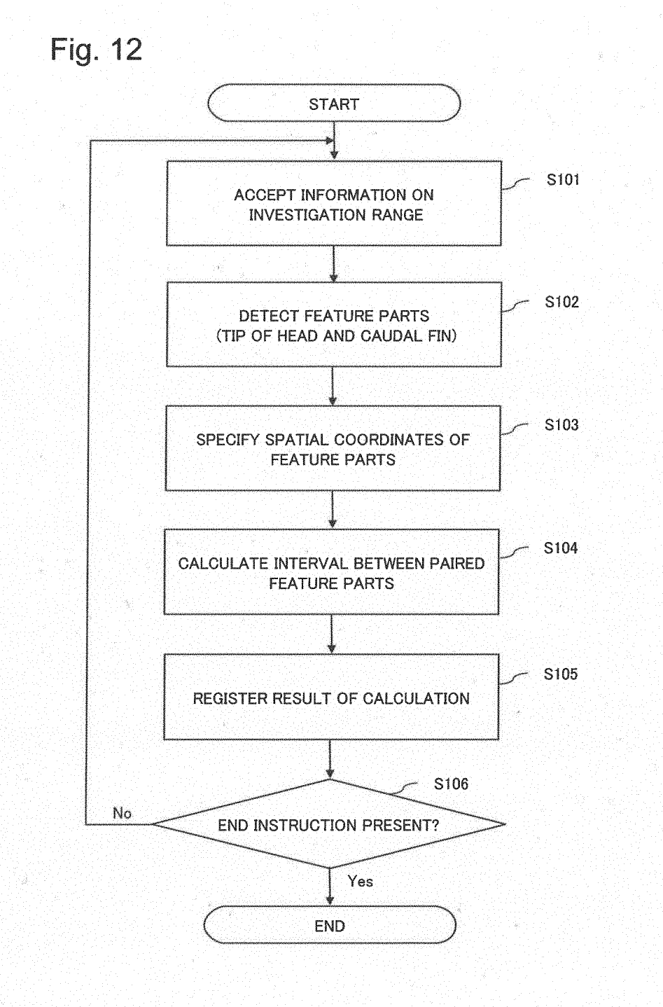

Next, one example of an operation of calculating (measuring) the length L of fish in the information processing device 20 is described with reference to FIG. 12. Note that FIG. 12 is a flowchart representing a processing procedure relevant to calculation (measurement) of the length L of fish to be executed by the information processing device 20.

For example, upon accepting information on the designated investigation range (the frame 50) in the captured image 41B on the operation screen (Step S101), the detection unit 30 of the information processing device 20 calculates the position of the investigation range (the frame 51) in the captured image 41A on the reference screen. Then, the detection unit 30 detects the predetermined feature parts (the tip of head and the caudal fin of fish) within the frames 50 and 51 in the captured images 41A and 41B using, for example, the reference data (Step S102).

Thereafter, concerning the tip of head and the caudal fin being the detected feature parts, the specification unit 31 specifies, by triangulation, position coordinates in a coordinate space using, for example, the interval information on the interval between the cameras 40A and 40B (capturing positions) or the like (Step S103).

Then, based on the specified position coordinates, the calculation unit 32 calculates the interval L between the paired feature parts (the tip of head and the caudal fin) as the length of fish (Step S104). Thereafter, the calculation unit 32 registers a result of calculation in the storage 23 in the state of being associated with predetermined information (for ample, a capturing date and time) (Step S105).

Thereafter, the control device 22 of the information processing device 20 determines whether an instruction to end the measurement of the length L of fish has been input by an operation performed by, for example, an observer on the input device 25 (Step S106). Then, when the end instruction has not been input, the control device 22 stands by for next measurement of the length L of fish. Further, when the end instruction has been input, the control device 22 ends the operation of measuring the length L of fish.

The information processing device 20 of the second example embodiment includes the function of detecting, using the detection unit 30, the tip of head parts and the caudal fin parts of fish necessary for the measurement of the length L of fish in the captured images 41A and 41B by the cameras 40A and 40B. Further, the information processing device 20 includes the function of specifying, using the specification unit 31, position coordinates in a coordinate space representing positions of the detected tip of head parts and the caudal fin parts of fish. Still further, the information processing device 20 includes the function of calculating, using the calculation unit 32, the interval L between the tip of head and the caudal fin of fish as a length of fish based on the specified position coordinates. Thus, when an observer inputs, using the input device 25, the information on the range (the frame 50) to be investigated in the captured images 41A and 41B, the information processing device 20 is able to calculate the length L of fish and provide the observer with information on the length L of fish. In other words, an observer is able to obtain information on the length L of fish easily without labor, by inputting the information on the range (the frame 50) to be investigated in the captured images 41A and 41B to the information processing device 20.

Further, the information processing device 20 specifies (calculates) the position coordinates (spatial position coordinates) of the paired feature parts (the tip of head and the caudal fin) of fish by triangulation, and calculates, using the spatial position coordinates, the length L between the feature parts as the length of fish, and therefore can enhance accuracy in length measurement.

Further, when the reference data (the reference part images) for use in processing of detecting the feature parts by the information processing device 20 are centered on the edge of the measurement portion of fish to be subjected to length measurement, the edge position of the measurement portion can be prevented from varying depending on the target fish. This allows the information processing device 20 to further enhance reliability for the measurement of the length L of fish.

Further, the information processing device 20 includes the function of detecting the feature parts within the designated investigation range (the frames 50 and 51). Thus, the information processing device 20 is able to reduce a load on processing, in comparison with the case of detecting the feature parts throughout an entire captured mage.

Further, the information processing device 20 includes the function of determining, upon designation of the investigation range (the frame 50) made in one of the plurality of captured images, the investigation range (the frame 51) in another captured image. The information processing device 20 is able to reduce labor on an observer comparison with a case in which the observer has to designate the investigation range respectively in the plurality of captured images.

Note that, in the second example embodiment, the detection unit 30 includes the function of setting (calculating) the position of the investigation range (the frame 51) in one of the captured images 41A and 41B when the investigation range (the frame 50) to designate the target fish is designated by an observer or the like in another one. Instead of this, the detection unit 30 may include a function of prompting an observer or the like to input, for each of the captured images 41A and 41B, information on the investigation range to designate the target fish, and further, setting the positions of the investigation ranges (frames 50 and 51) based on the input information. That is, the positions of the investigation ranges (the frames 50 and 51) may be designated by an observer or the like in both of the captured images 41A and 41B, and the detection unit 30 may set the positions of the investigation ranges (the frames 50 and 51) in the respective captured images 41A and 41B based on the information on the designated positions.

### Third Example Embodiment

A third example embodiment according to the present invention will be described below. Note that, in the description of the third example embodiment, a component with a name identical to that of a component constituting the information processing device and the length measurement system of the second example embodiment will be denoted by an identical reference numeral, and repeated description of the common component will be omitted,

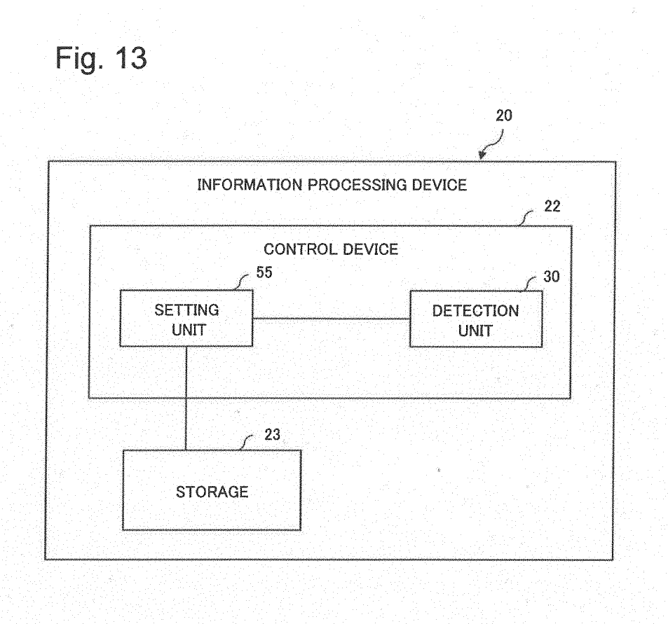

An information processing device 20 of the third example embodiment includes a setting unit 55 as represented in FIG. 13 in addition to the configuration of the second example embodiment. Note that the information processing device 20 includes the configuration of the second example embodiment, but, in FIG. 13, the specification unit 31, the calculation unit 32, the analysis unit 33, and the display control unit 34 are omitted in the drawing. Further, in FIG. 13, the storage 24, the input device 25, and the display device 26 are also omitted in the drawing.

The setting unit 55 includes a function of setting the investigation range for the detection unit 30 to investigate the positions of the feature parts (the tip of head and the caudal fin) in the captured images 41A and 41B. The investigation range is information to be input by an observer in the second example embodiment, whereas, in the third example embodiment, the setting unit 55 sets the investigation range, and thus, an observer does not need to input information on the investigation range. Owing this fact, the information processing device 20 of the third example embodiment is able to further enhance convenience.

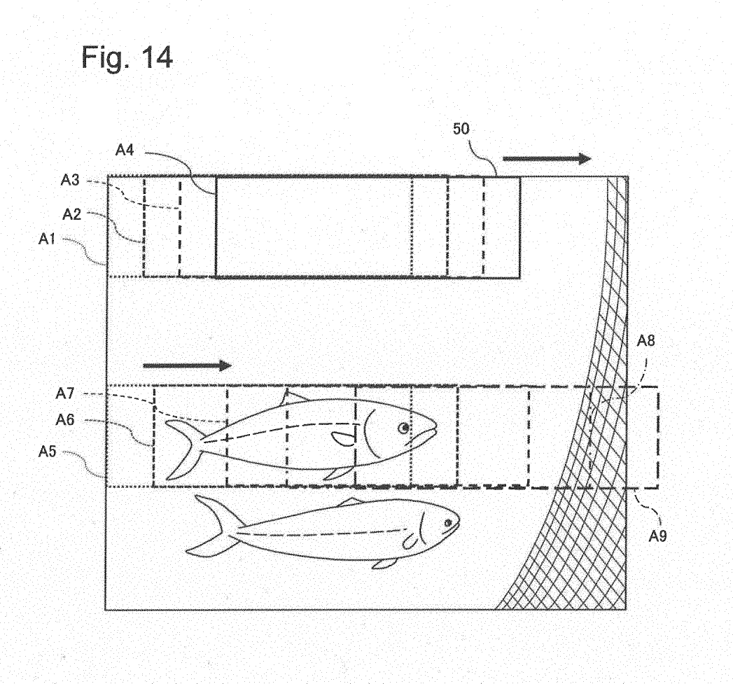

In the third example embodiment, the storage 23 stores information to determine the shape and the size of the investigation range as information for use by the setting unit 55 in order to set the investigation range. For example, when the shape and the size of the investigation range are the shape and the size of the frame 50 represented by a solid line in FIG. 14, information on the shape and information on longitudinal and lateral lengths of the frame 50 are registered in the storage 23. Note that the frame 50 is, for example, a range having a size corresponding to a size of one fish in the captured image that an observer considers as appropriate for measurement, and respective longitudinal and lateral lengths thereof are variable by an operation by the observer the like on the input device 25.

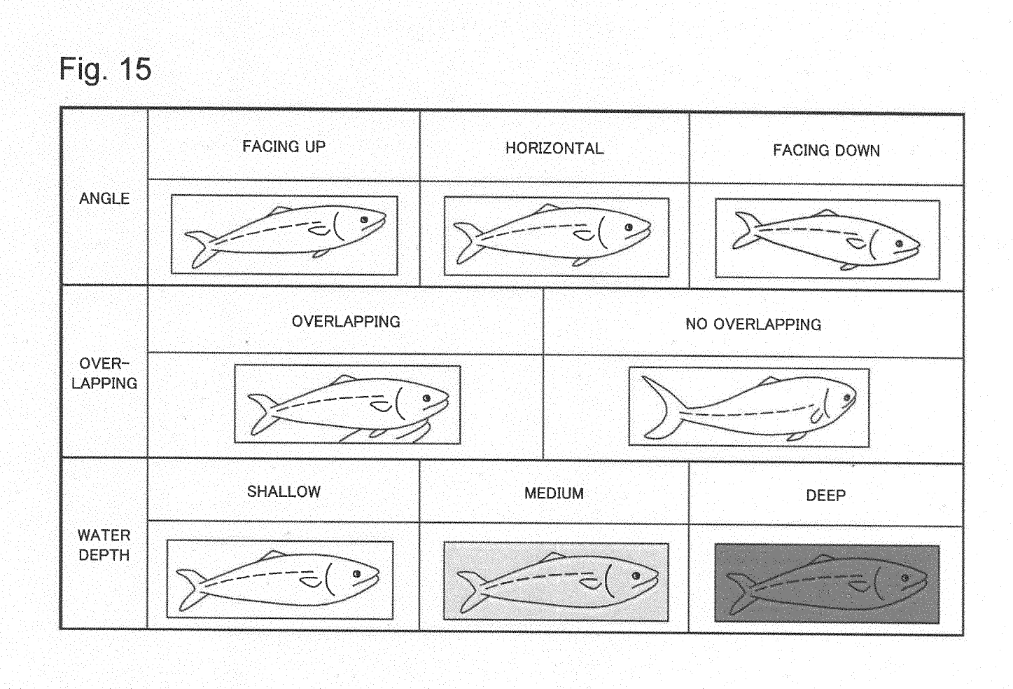

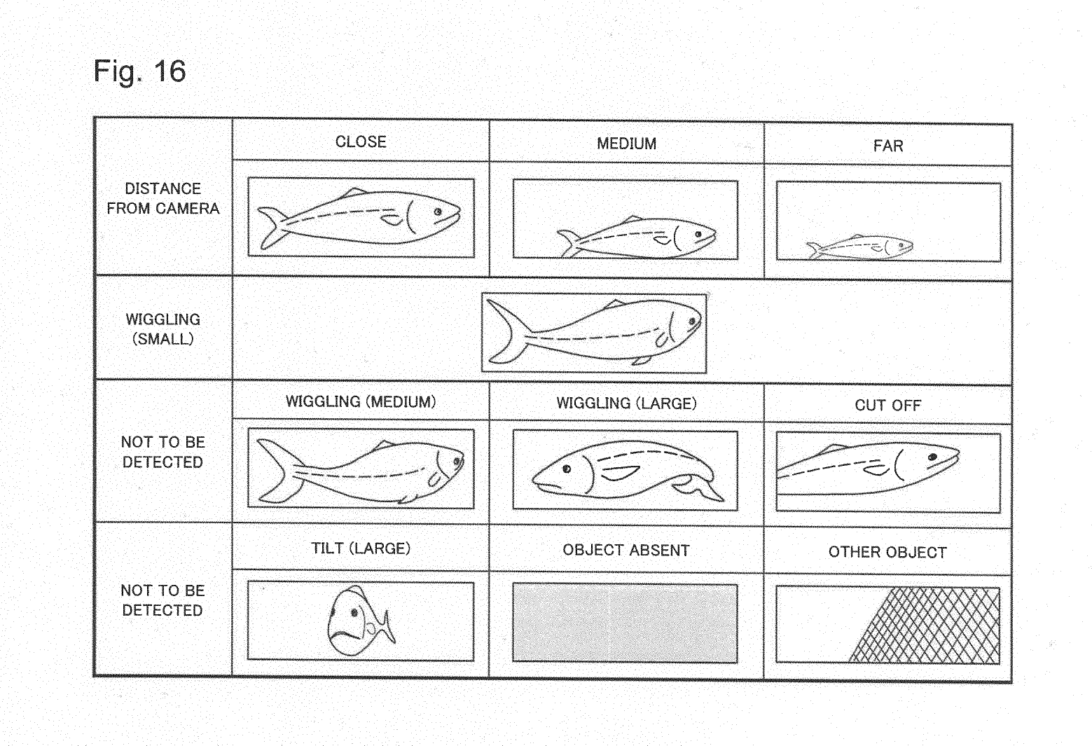

Furthermore, the storage 23 stores a captured image of a whole target object (that is, herein, a target fish body) to be measured as a sample image. Herein, as represented in FIGS. 15 and 16, a plurality of sample images captured in mutually different capturing conditions are registered. These sample images of the whole target object (target fish body) can be also obtained by machine learning using a large number of captured images by capturing the target object as training data (teaching images), in a manner similar to the sample images of the feature parts (the tip of head and the caudal fin).

The setting unit 55 sets the investigation range in a manner as follows. For example, when information to request for the length measurement is input by an observer through an operation on the input device 25, the setting unit 55 reads information on the frame 50 from the storage 23. Note that the information to request for the length measurement may be, for example, information on instruction to pause an image during reproduction of the captured images 41A and 41B, or may be information on instruction to reproduce a moving image during stop of the captured images 41A and 41B. Further, the information to request for the length measurement may be information representing that a mark of “start measurement” displayed on the display device 26 has been indicated through an operation of an observer on the input device 25. Furthermore, the information to request for the length measurement may be information representing that a predetermined operation on the input device 25 (for example, a keyboard operation) meaning measurement start has been performed.

After reading the information on the frame 50, the setting unit 55 moves the frame 50 having the shape and the size represented in the read information, sequentially at predetermined intervals, like Frame A1→Frame A2→Frame A3→ . . . Frame A9→ . . . represented in FIG. 14, in the captured image. Note that a configuration of making the interval of movement of the frame 50 variable as appropriate by, for example, an observer may be included in the information processing device 20.

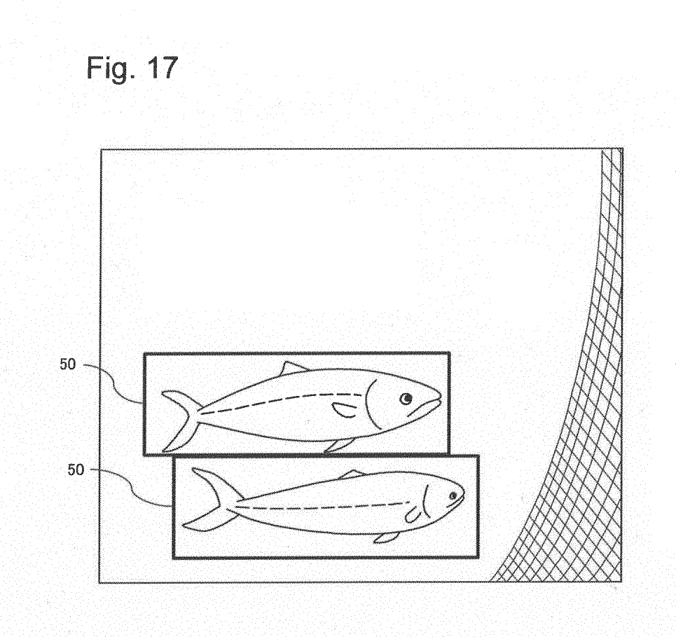

Further, while moving the frame 50, the setting unit 55 determines a degree of matching (similarity) between a captured image portion demarcated by the frame 50 and the sample image of the target object as in FIGS. 15 and 16, by using a method used in, for example, a template matching. Then, the setting unit 55 defines the frame 50 having the degree of matching equal to or larger than a threshold value (for example, 90%) as the investigation range. For example, in an example of the captured image in FIG. 17, two frames 50 are defined by the setting unit 55 on one captured image. In this case, for the respective two frames 50, the detection unit 30 executes processing of detecting the feature parts and the specification unit 31 specifies the spatial position coordinates of the feature parts in a coordinate space, as described in the second example embodiment. Then, for the respective two frames 50, the calculation unit 32 calculates the interval between the paired feature parts (herein, the length L of fish). Note that, for example, when the information on instruction to pause an image is input as the information to request for the length measurement, the setting unit 55 sets the investigation range in the captured image being paused. By setting the investigation range in this manner, the interval between the paired feature parts is calculated as described above. Further, for example, when the information on instruction to reproduce a moving image is input as the information to request for the length measurement, the setting unit 55 sets the investigation range successively for a moving image being reproduced. By setting the investigation range in this manner, the interval between the paired feature parts is calculated as described above.

Note that, upon setting the position of the investigation range (the frame 50) in one of the captured images 41A and 41B as described above, the setting unit 55 sets the position of the investigation range (the frame 51) in another one depending on the position of the frame 50. However, instead of this, the setting unit 55 may include a function as follows. That is, the setting unit 55 may set the investigation ranges (the frames 50 and 51) in the respective captured images 41A and 41B by moving (scanning) the frames 50 and 51 in a manner similarly as described above.

Further, the setting unit 55 may include a function of temporarily determining the positions of the investigation ranges set as described above, clearly indicating the temporarily determined positions of the investigation ranges (the frames 50 and 51) in the captured images 41A and 41B, and causing, using the display control unit 34, the display device 26 to display a message for prompting an observer or the like to confirm the investigation ranges. Then, when information that the positions of the investigation ranges (the frames 50 and 51) (for example, the fact that the frames 50 and 51 surround the same fish, and the like) have been confirmed is input by an operation performed by the observer or the like on the input device 25, the setting unit 55 may define the positions of the investigation ranges. Further, when information that the positions of the investigation ranges (the frames 50 and 51) are desired to be changed is input by the operation performed by the observer or the like on the input device 25, the setting unit 55 may allow adjustment of the positions of the investigation ranges (the frames 50 and 51), and may define the changed positions of the frames 50 and 51 as being investigation ranges.

Configurations other than the above in the information processing device 20 and the length measurement system of the third example embodiment are similar to those in the information processing device 20 of the second example embodiment.

The information processing device 20 and the length measurement system of the third example embodiment include configurations similar to those in the second example embodiment, and thus, are able to obtain advantageous effects similar to those in the second example embodiment. Moreover, the information processing device 20 and the length measurement system of the third example embodiment include the setting unit 55, and thus, an observer no longer has to input information for defining the investigation range, which can reduce labor on the observer. Therefore, the information processing device 20 and the length measurement system of the third example embodiment are able to further enhance convenience relating to the measurement of the length of target object. For example, it becomes possible for the information processing device 20 to perform processing of synchronizing the captured images 41A and 41B, and thereafter calculating the length L of fish using the setting unit 55, the detection unit 30, the specification unit 31, and the calculation unit 32 while reproducing the captured images 41A and 41B, in succession until the end of reproduction. Note that there are various methods conceived as a method for the information processing device 20 to start a series of processing of synchronization of images, reproduction of captured images, and calculation of the length of fish in succession as described above. For example, when start of processing is instructed by an operation on the input device 25, the information processing device 20 may start the above-described series of processing. Further, when the captured images 41A and 41B are registered (registered) in the storage 23 of the information processing device 20, the information processing device 20 may start the above-described series of processing by detecting the registration. Furthermore, when the captured images 41A and 41B to be reproduced are selected, the information processing device 20 may start the above-described series of processing based on the information on the selection. Herein, d that an appropriate method may be employed from among such various methods.

### Other Example Embodiments

Note that the present invention may employ various example embodiments, without limitation to the first to third example embodiments. For example, in the second and third example embodiments, the information processing device 20 includes the analysis unit 33, but an analysis on information obtained by observing the length L of fish may be executed by an information processing device different from the information processing device 20, and, in this case, the analysis unit 33 may be omitted.

Further, in the second and third example embodiments, examples have been given in which the paired feature parts are the tip of head and the caudal fin of fish. However, for example, configuration may be made such that a set of a dorsal fin and a ventral fin is also further detected as the paired feature parts, and a length between the dorsal fin and the ventral fin may be also calculated as well as the length between the tip of head and the caudal fin. As a method to detect those dorsal fin and ventral fin as the feature parts from the captured image, a detection method similar to the detection of the tip of head and the caudal fin can be used.

Further, for example, when the length between the tip of head and the caudal fin and the length between the dorsal fin and the ventral fin are calculated, and when a relation between length and weight that enables estimation of a weight of fish based on those lengths can be obtained, the analysis unit 33 may estimate the weight of fish based on the those calculated lengths.

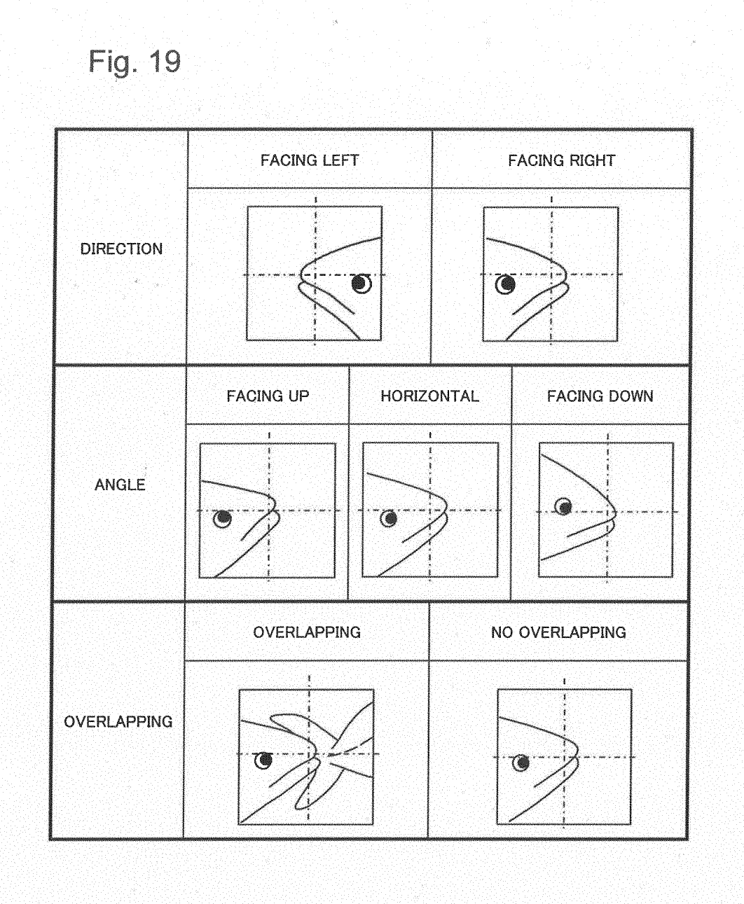

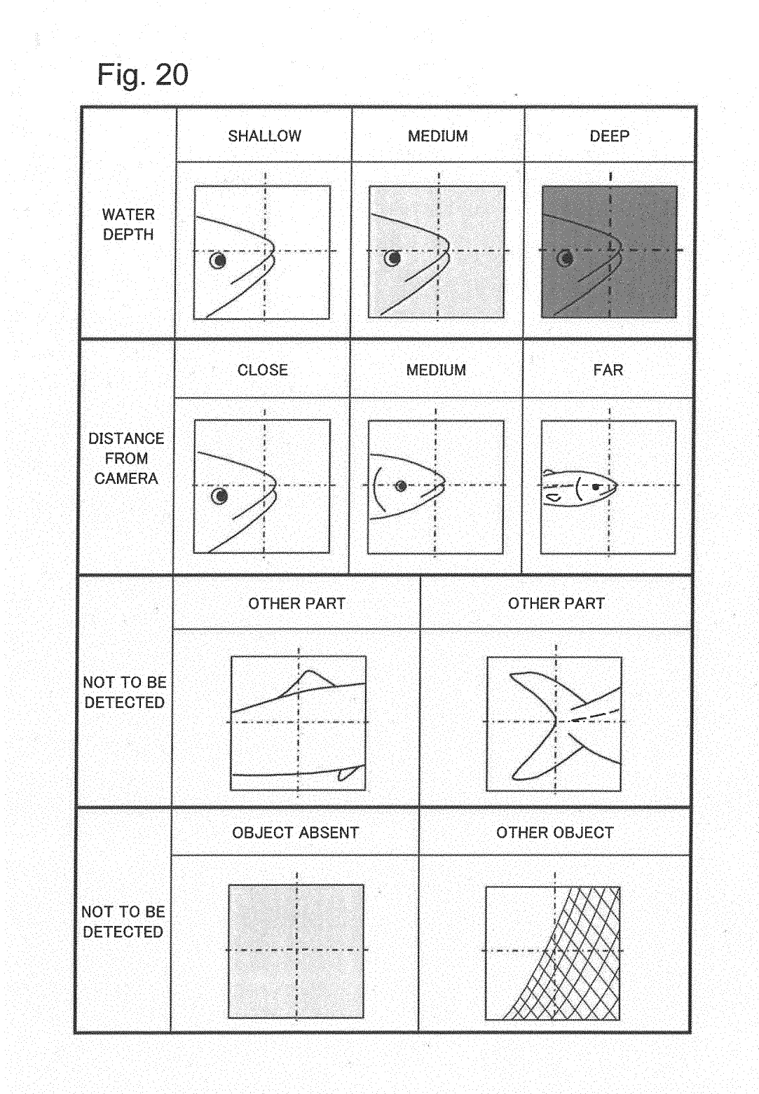

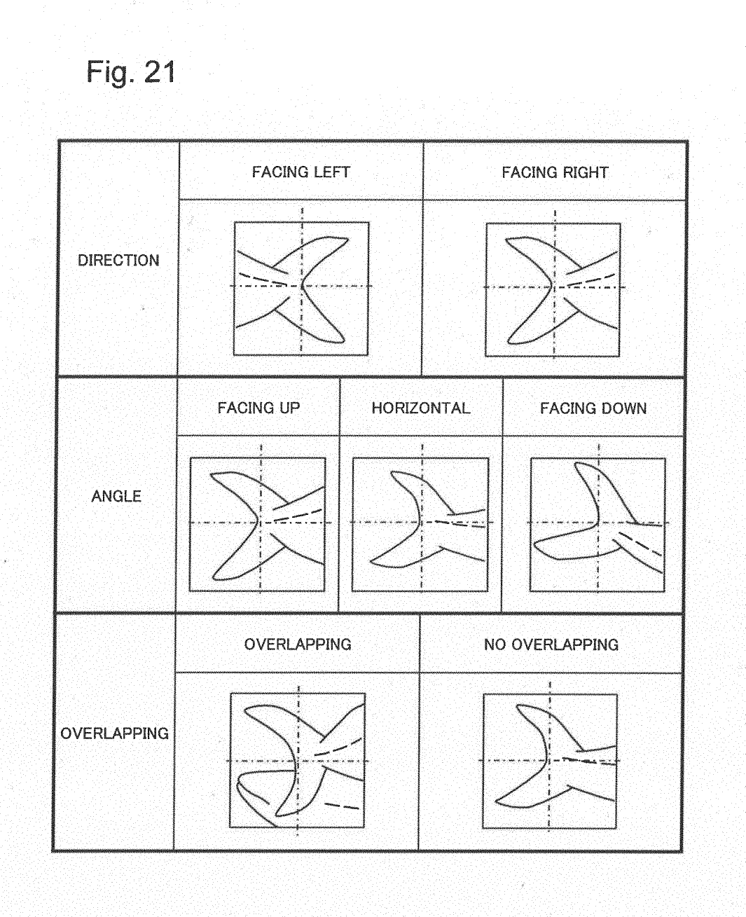

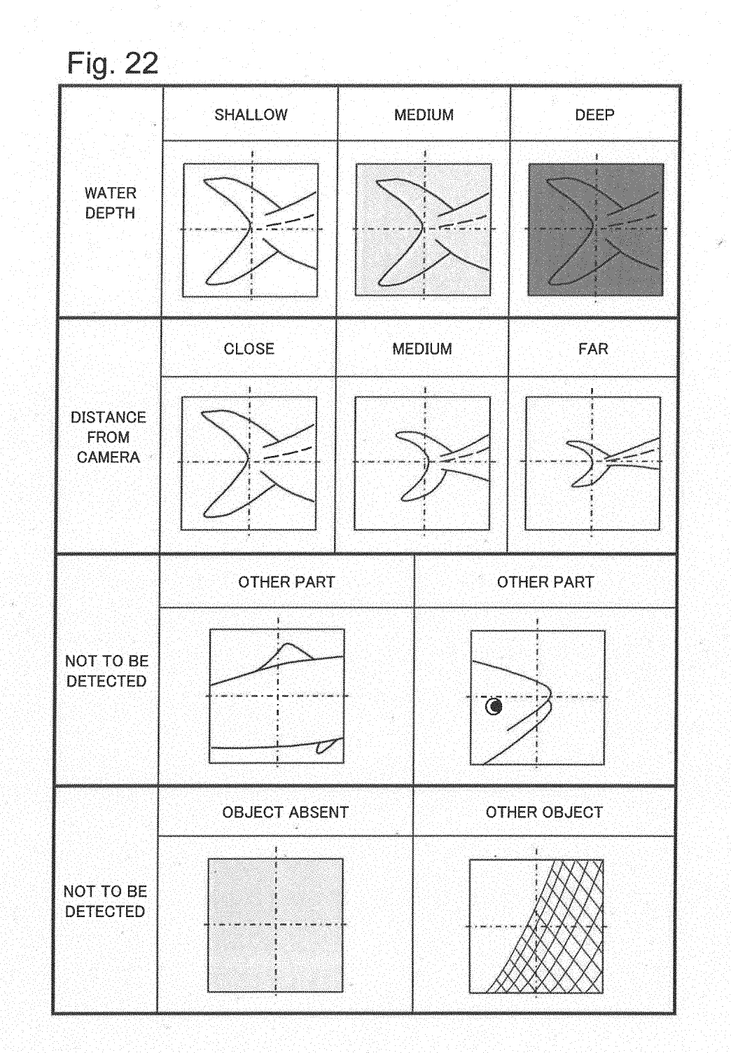

Further, in the description of the second example embodiment, the example in FIG. 8 has been given as the reference data with respect to the feature parts. However, there may be more types of the reference data of the feature parts as represented in FIGS. 19 to 22. Note that FIGS. 19 and 20 are examples of the reference data relating to the tip of head of fish, and FIGS. 21 and 22 are examples of the reference data relating to the caudal fin of fish. Further, as the reference data of the caudal fin of fish, for example, images of the caudal fin of fish in a wiggling motion may be further included. Further, cut-off data in which a part of the tip of head or the caudal fin of fish is not included in the captured image may be given as the reference data not to be detected. As described above, the type and the number of the reference data are not limited,

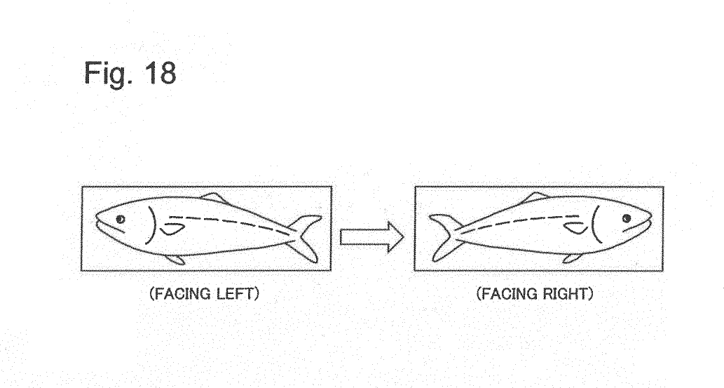

Further, in each of the second and third example embodiments, when the sample images of the feature parts (the tip of head and the caudal fin) or the whole object (fish body) are generated by machine learning using the training data, the training data may be reduced as follows. For example, when the captured image of a fish facing left as represented in FIG. 18 is acquired as training data, training data of a fish facing right may be obtained by performing processing of lateral inversion on the image of the fish facing left.

Further, in the second example embodiment, the information processing device 20 may perform, at appropriate timing such as before starting processing of detecting the feature parts, image processing of improving muddiness of water in the captured image, or image processing of correcting distortion of fish body due to fluctuation of water. Further, the information processing device 20 may perform image processing of correcting the captured image in consideration of a capturing condition such as a water depth, brightness, or the like of an object. Further, in the third example embodiment, the information processing device 20 may execute image processing similar to the above, at appropriate timing such as before starting processing of defining the investigation range. In this manner, the information processing device 20 is able to further enhance accuracy in the length measurement of the target object by performing the image processing (image correction) on the captured image in consideration of a capturing environment. Further, the information processing device 20 is able to obtain an advantageous effect of being able to reduce the number of pieces of reference data using the captured image on which image correction has been performed in such a manner.

Further, in the second and third example embodiments, description has been given using an example of a fish as the target object. However, the information processing device 20 having a configuration described in the second and third example embodiments is also applicable to another object. In other words, the information processing device 20 of the second and third example embodiments can be also applied to length measurement of an object other than a fish, as long as the object has features distinguishable from other portions at both end portions of a portion to be subjected to length measurement.

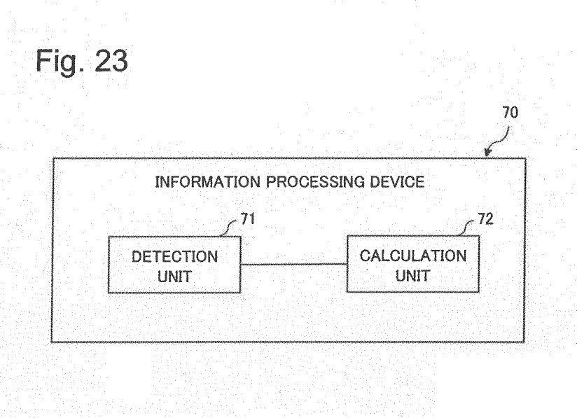

Further, FIG. 23 simplistically represents a configuration of an information processing device of another example embodiment according to the present invention. An information processing device 70 in FIG. 23 includes, as functional units, a detection unit 71 and a calculation unit 72. The detection unit 71 includes a function of detecting feature parts of a target object to be measured from a captured image in winch the target object is captured. The feature parts are paired parts and respectively have a predetermined feature. The calculation unit 72 includes a function of calculating a length between the paired feature parts using a result of detection by the detection unit 71. The information processing device 70 is able to obtain an advantageous effect of being able to easily and accurately detect a length of object to be measured using the captured image, by including a configuration as described above.

The present invention has been described using the example embodiments described above as an exemplary example. However, the present invention is not limited to the above-described example embodiments. In other words, various modes that a person skilled in the art can understand can be applied to the present invention within the scope of the present invention.

This application is based upon and claims the benefit of priority from Japanese Patent Application No. 2016-194268, filed on Sep. 30, 2016, the disclosure of which is incorporated herein in its entirety.

Some or all of the above-described example embodiments can be described as the following supplementary notes, but are not limited to the following.

(Supplementary Note 1)

An information processing device includes:

a detection unit that detects feature parts of a target object to be measured from a captured image in which the target object is captured, the feature parts being paired and respectively having a predetermined feature; and

a calculation unit that calculates a length between the paired feature parts using a result of detection by the detection unit.

(Supplementary Note 2)

The information processing device according to Supplementary note 1 further includes

a specification unit that specifies position coordinates representing positions of the detected feature parts in a coordinate space using display position information and interval information, the display position information representing display positions where the detected feature parts are displayed in each of a plurality of captured images taken by capturing the target object from mutually different positions, the interval information representing an interval between capturing positions where the plurality of captured images have, been respectively captured.

The calculation unit calculates the length between the paired feature parts using the specified position coordinates of the feature parts.

(Supplementary Note 3)

In the information processing device according to Supplementary note 1 or 2, the detection unit detects the feature parts within a designated investigation range of the captured image.

(Supplementary Note 4)

The information processing device according to Supplementary note 2 further includes

a range following unit that determines, when the designated investigation range to detect the feature parts by the detection unit is designated in one of the plurality of the captured images, a position of the investigation range in the captured image for which the investigation range is not designated using information on a position of the investigation range in the captured image for which the investigation range is designated and the interval information on the interval between the capturing positions of the captured images.

(Supplementary Note 5)

The information processing device according to Supplementary note 1 or 2 further includes

a setting unit that sets an investigation range where detection processing is executed by the detection unit n the captured image.

(Supplementary Note 6)

In the information processing device according to any one of Supplementary notes 1 to 5, the detection unit detects the feature parts from the captured image using a reference part image representing each sample image of the feature parts.

(Supplementary Note 7)

In the information processing device according to Supplementary note 2, the detection unit detects, as the feature parts, a part centered on one of both ends portion of a measurement portion to measure the length, and a part centered on the other of both ends portion of the measurement portion using reference part images. Each of the reference part images is a sample image of one or the other of the feature parts and is an image in which a center of the image represents one or the other of both ends of the measurement portion. The specification unit specifies coordinates representing each center position of the detected feature parts. The calculation unit calculates a length between centers of the paired feature parts.

(Supplementary Note 8)

In the information processing device according to Supplementary note 2 or 7, the specification unit specifies, using triangulation, the coordinates representing positions of the feature parts in the coordinate space,

(Supplementary Note 9)

A length measurement system includes:

an imaging device that captures a target object to be measured; and

an information processing device that calculates a length between feature parts of the target object in a captured image captured by the imaging device, the feature parts being paired and respectively having a predetermined feature.

The information processing device includes:

a detection unit that detects the feature parts of the target object from the captured image in which the target object is captured; and

a calculation unit that calculates the length between the paired feature parts using a result of detection by the detection unit.

(Supplementary Note 10)

A length measurement method includes:

detecting feature parts of a target object to be measured from a captured image in which the target object is captured, the feature parts being paired and respectively having a predetermined feature; and

calculating a length between the paired feature parts using a result of the detection.

(Supplementary Note 11)

A program storage medium stores a computer program that causes a computer execute:

detecting feature parts of a target object to be measured from a captured image in which the target object is captured, the feature parts being paired and respectively having a predetermined feature; and

calculating a length between the paired feature parts using a result of the detection.

### REFERENCE SIGNS LIST

1, 20 Information processing device
2, 30 Detection unit
3, 31 Specification unit
4, 32 Calculation unit
10 Length measurement system
11A, 11B Imaging device
50, 51 Frame
55 Setting unit

1. An information processing device comprising:
a processor configured to:
detect feature parts of a target object to be measured from a captured image in which the target object is captured, the feature parts being paired and respectively having a predetermined feature; and
calculate a length between the paired feature parts detected.

2. The information processing device according to claim 1,
wherein the processor further specifies position coordinates representing positions of the detected feature parts in a coordinate space using display position information and interval information, the display position information represents display positions where the detected feature parts are displayed in each of a plurality of captured images taken by capturing the target object from mutually different positions, the interval information represents an interval between capturing positions where the plurality of captured images have been respectively captured, and
wherein the processor calculates the length between the paired feature parts using the specified position coordinates of the feature parts.

3. The information processing device according to claim 1, wherein the processor detects the feature parts within a designated investigation range of the captured image.

4. The information processing device according to claim 2,
wherein the processor further determines, when an investigation range to detect the feature parts is designated in one of the plurality of the captured images, a position of the investigation range in the captured image for which the investigation range is not designated using information on a position of the investigation range in the captured image for which the investigation range is designated and the interval information on the interval between the capturing positions of the captured images.

5. The information processing device according to claim 1, wherein the processor further sets an investigation range where detection processing is executed by the detection means in the captured image.

6. The information processing device according to claim 1, wherein the processor detects the feature parts from the captured image using a reference part image representing each sample image of the feature parts.

7. The information processing device according to claim 2, wherein the processor detects, as the feature parts, a part centered on one of both ends portion of a measurement portion to measure the length, and a part centered on the other of both ends portion of the measurement portion using reference part images, each of the reference part images is a sample image of one or the other of the feature parts and is an image in which a center of the image represents one or the other of both ends of the measurement portion,
wherein the processor specifies coordinates representing each center position of the detected feature parts, and
wherein the processor calculates a length between centers of the paired feature parts.

8. The information processing device according to claim 2, wherein the processor specifies, using triangulation, the position coordinates representing positions of the feature parts in the coordinate space.

9. (canceled)

10. A length measurement method comprising:
by a processor,
detecting feature parts of a target object to be measured from a captured image in which the target object is captured, the feature parts being paired and respectively having a predetermined feature; and
calculating a length between the paired feature parts using a result of the detection.

11. A non-transitory program storage medium storing a computer program that causes a computer to execute:
detecting feature parts of a target object to be measured from a captured image in which the target object is captured, the feature parts being paired and respectively having a predetermined feature; and
calculating a length between the paired feature parts using a result of the detection.
